(19) United States
(12) Patent Application Publication
(10) Pub. No.: US 2019/0353195 A1
(43) Pub. Date: Nov. 21, 2019

(54) FLOATING, CAPTIVE ARRANGEMENT OF A CONNECTION ELEMENT ON A COMPONENT

(71) Applicant: Heiko Schmidt, Lappersdorf (DE)

(72) Inventor: Heiko Schmidt, Lappersdorf (DE)

(21) Appl. No.: 16/412,934

(22) Filed: May 15, 2019

(30) Foreign Application Priority Data
May 17, 2018 (DE) 10 2018 111 957.7

(51) Int. Cl. F16B 37/04; F16B 39/12; F16B 5/02

(52) U.S. Cl. CPC F16B 37/044; F16B 5/025; F16B 39/12

(57) ABSTRACT

The invention relates to a floating, captive arrangement of a connection element on a component, in which the connection element extends along a longitudinal axis (LA) and has at least a head section and a shaft section, which adjoins along the longitudinal axis (LA) and is set back relative to the head section, in which the shaft section is passed, at least in sections, through a through-opening in the component and is connected, at least in the area of the free end of the shaft section opposing the head section, to a retaining plate element in such a way that the connection element is floatingly and captively arranged on the component, wherein the head section has first locking means and/or the retaining plate element has third locking means and the component has corresponding second locking means, wherein the first and/or third locking means interact with the second locking means in such a way that the connection element received, at least in sections, in the through-opening of the component is secured against at least section-wise twisting about the longitudinal axis (LA) relative to the component.

### CROSS REFERENCE TO RELATED APPLICATION

This application is based on and claims the benefit of priority from German Patent Application No. DE 10 2018 111 957.7, filed on May 17, 2018, the contents of which are incorporated herein by reference.

### BACKGROUND OF THE INVENTION

### 1. Field of the Invention

The invention relates to a floating, captively secured arrangement of a connection element on a component.

### 2. Description of the Related Art

In the field of joining technology, for numerous applications it is necessary to secure a preferably threaded connection element, such as a nut, on a component surface. In order to achieve a tolerance compensation in terms of the bolting point in and with respect to the component surface, preference is given to a floating arrangement of the connection element on the component surface. For example, a typical assembly situation concerns a component that can only be accessed on one side, for which a floating arrangement of a connection element is required on the non-accessible component surface.

To this end, use is made of, for example, connection elements with a cage-like mounting made of a preferably planar metal material, wherein the connection element is received in the cage-like mounting made of a permanently deformable planar metal material and via which said element is arranged floatingly on the component surface or in a pre-perforation or drilled hole provided therein.

Threaded connection elements of such design are commonly also known as “cage nut elements” or “cage nuts”. A tolerance compensation of the bolting point is achieved in the x/y direction, i.e., in the plane of the component surface, by means of such cage nuts. The cage of such cage nuts is commonly produced as a stamped part and welded onto a plate element. A smaller nut element, which is movable in the x and y direction or in the plane of the component surface, is enclosed in this cage. A disadvantage lies in the fact that the production of the cage and the welding of the same on the plate element are both labor- and cost-intensive, especially since this assembly is generally performed manually. Furthermore, such cage nuts are heavy and consequently require a large quantity of material.

Also known are assembly situations in which the connection element, preferably a nut element, is arranged floatingly and captively in a blind rivet element, which is passed with the pre-mounted connection element through a pre-perforation in a component made of a sheet metal material and then connected to the same via a rivet connection. The blind rivet element itself serves for floatingly and captively mounting the connection element. A disadvantage is that known arrangements require blind rivet elements with comparatively large outer diameters in order to achieve floating and captive mounting of connection elements. This gives rise to disadvantages, particularly in the case of cramped assembly conditions. The known solutions also require increased material consumption.

### SUMMARY OF THE INVENTION

Given this background, the object of the invention is to specify a floating and captive arrangement of a connection element on a component, which is furthermore twist-proof, requires less material and is suitable for use in cramped assembly conditions.

One of the key aspects of the floating, captive arrangement according to the invention lies in the fact that the connection element extends along a longitudinal axis and has at least a head section and a shaft section adjoining thereto along the longitudinal axis, which shaft section is set back relative to the head section, wherein the shaft section is passed, at least in sections, through a through-opening in the component and is connected, at least in the area of the free end of the shaft section opposite the head section, to a retaining plate element in such a way that the connection element is floatingly and captively arranged on the component, wherein the head section has first locking means and/or the retaining plate element has third locking means and the component has respective corresponding second locking means, wherein the first and/or third locking means interact with the second locking means in such a way that the connection element, which is received, at least in sections, in the through-opening of the component, is secured against at least section-wise twisting about the longitudinal axis relative to the component. The component is thus preferably received between the head section of the connection element and the retaining plate element. The assembly effort and the quantity of material required for such a floating, captive and twist-proof arrangement of a connection element on a component can thus be substantially reduced in a particularly advantageous manner. In particular, the arrangement according to the invention can be produced in a fully automated fashion, thereby achieving a considerable cost savings compared to a manual assembly of the cage in the case of cage nuts. The installation space needed for such an arrangement is also reduced in comparison to known solutions, and less power is consumed in comparison to known cage solutions because weld connections are omitted.

The first, second and third locking means are advantageously arranged in the area of the through-opening of the component. These means are adapted to one another in terms of number, shape and/or positioning, specifically in such a way that at least a part or at least a section of the first locking means comes in abutment with at least a part or at least a section of the second locking means when the connection element is turned. In a particularly advantageous manner, a twist-proof arrangement of the connection element on the component is thus additionally achieved while retaining the desired floating and captive arrangement.

Another advantage is that the retaining plate element produced from a sheet material has a through-opening, the diameter and/or cross-sectional shape of which is adapted, at least in sections, to the diameter and/or to the cross-sectional shape of the shaft section of the connection element in the area of the free end.

The retaining plate element is preferably captively connected to the free end of the shaft section of the connection element, wherein in another embodiment variant, the retaining plate element is likewise connected in a twist-proof manner or rigidly to the free end of the shaft section of the connection element.

Another advantage is that the retaining plate element is arranged slidably along the longitudinal axis on the shaft section of the connection element. As an alternative or in addition, the free end of the shaft section is received in the through-opening of the retaining plate element in such a way that the free end springs back from the underside of the retaining plate element into the through-opening. The retaining plate element is thus advantageously secured against at least section-wise twisting about the longitudinal axis of the connection element at the free end of the shaft section of the connection element. Thus, a pre-tensioning can be advantageously introduced upon screwing the arrangement according to the invention to a further component; specifically, the connection element, the component, the retaining plate element and the further component can be clamped together along the longitudinal axis or a pre-tensioning can be introduced via the torque of the screwing means. The attachment of the retaining plate element to the shaft section of the connection element is preferably selected such that as the torque is applied, it is possible to slide the retaining element along the shaft section with a force that is still less than the pre-tensioning force required for producing the final screw connection.

Another advantage is that the retaining plate element has an outer contour and/or outer dimensions that block a passing through of the retaining plate element through the through-opening of the component.

In an embodiment variant, the first locking means are formed by at least one groove-like recess formed in the underside of the head section and the corresponding second locking means are formed by at least one web section protruding from the upperside of the component in the direction of the longitudinal axis. As an alternative, the first locking means can be formed by at least one web section protruding from the underside of the head section and the corresponding second locking means can be formed by at least one groove-like recess formed in the upperside of the component. It goes without saying that both embodiment variants are also achievable in mixed fashion, i.e., the first locking means of the head section can be formed from at least one groove-like recess as well as a web section, which interact with corresponding second locking means of the component in the form of a web section and a groove-like recess, respectively.

Particularly advantageously the groove-like recess has, for example, a U-shaped or C-shaped cross-sectional shape and/or the at least one groove-like recess and the at least one web section extend radially to the longitudinal axis, wherein the at least one web section is adapted in terms of its radial longitudinal extension to the radial longitudinal extension of the groove-like recess. The web sections have a width that is less than the width of the groove-like recesses. This advantageously gives rise to a floating area in each case, which in spite of the anti-twist lock still ensures a floating arrangement of the connection element.

In a preferred embodiment variant, the first and second locking means are each formed by at least two groove-like recesses or at least two web sections, in other words at least two groove-like recesses or web sections are provided on the head section as well as on the component.

In an alternative embodiment variant, the first locking means can be formed by at least one nose-like projection protruding from the underside of the head section and the corresponding second locking means can be formed by at least one, preferably circular locking recess formed in the upperside of the component. As an alternative to this, the first locking means can be formed by at least one, preferably circular locking recess formed in the underside of the head section and the corresponding second locking means can be formed by at least one nose-like projection protruding from the upperside of the component. Again, mixed forms of these embodiments are also possible. It is particularly advantageous if the circular locking recesses and the nose-like projections are each adapted to one another in terms of number, shape and/or positioning relative to the longitudinal axis.

In another alternative embodiment variant, the first locking means are formed by a cross-sectional shape of the head section or at least from an edge section of the head section deviating from the circular shape, wherein the corresponding second locking means are formed by at least one, preferably several locking bead elements, which protrude from the upperside of the component. An anti-twist lock that is particularly easy to produce is thus achieved.

Further advantageously also the third locking means can be formed by a cross-sectional shape of the retaining plate element or at least from an edge section of the retaining plate element deviating from the circular shape, which interact with the corresponding second locking means, which are formed by at least one, preferably several locking bead elements that protrude from the underside of the component. A twist locking of the retaining plate element relative to the component is thus also advantageously achieved. Said locking bead elements are advantageously molded into the sheet material that forms the component and can thus be produced easily and inexpensively.

The connection element is preferably configured as a threaded connection element, in particular as a nut element or bolt element or screw element, and the through-opening in the component and/or the through-opening in the retaining plate element is/are formed by a pre-perforation or a drilled hole.

In another advantageous embodiment variant, the component is formed by a blind rivet element with a through-opening comprising a retaining section, an abutment section, a rivet shaft section and a rivet flange, which adjoin one another along the longitudinal axis. According to the invention, the connection element is fed through the through-opening of the blind rivet element, where it is arranged floatingly, captively, and in an inventively twist-proof manner. To this end, the through-opening extends over the retaining section to the abutment section and transitions along the abutment section, widening in a cross section, into a preferably cylindrical hollow rivet chamber, which is enclosed by the rivet shaft section and by the adjoining rivet flange. After the connection element is introduced into the blind rivet element, the free end of the shaft section extends into the hollow rivet chamber and from there preferably into the area of the rivet shaft section.

Also advantageously the abutment section forms an annular abutment surface that runs obliquely to the longitudinal axis, and an abutment plate element with a through-opening and an upperside edge bevel is arranged between the retaining pate element and the abutment section captively arranged on the free end of the shaft section, wherein the abutment plate element with the edge bevel lies flatly on the abutment surface of the abutment section extending obliquely to the longitudinal axis. Advantageously, the abutment plate element extends over the entire hollow rivet chamber and thus forms a plane or flat abutment surface for the retaining plate element. Both the retaining plate element and the abutment plate element are preferably disc-shaped, in particular washer-shaped.

Another advantage is that the diameter of the through-opening of the abutment plate element approximately corresponds to the diameter of the through-opening of the retaining section; i.e., the through-opening of the retaining section continues in the through-opening of the abutment plate section and thus forms a “floating space” for the connection element.

The retaining plate element advantageously abuts on the underside of the abutment plate element, wherein the outer diameter of the retaining plate element is chosen such that it is smaller than the diameter of the hollow rivet chamber and larger than the diameter of the through-opening of the abutment plate element. As a result, the retaining plate element fastened to the free end of the connection element can be moved in the x-, y-direction in the hollow rivet chamber; i.e., the connection element is thus arranged floatingly in the through-opening of the blind rivet element.

In an alternative embodiment variant, the third locking means can be formed by at least one nose-like projection and/or web section protruding from the upperside of the retaining plate element, which projection and/or web section interacts with corresponding second locking means in the form of recesses. Obviously, the third locking means can be formed vice versa by at least one recess formed in the upperside of the retaining plate element, which interacts with corresponding second locking means in the form of a nose-like projection and/or web section protruding from the underside of the component.

The subject matter of this invention is also a prefabricated assembly comprising an arrangement according to the invention. The component of the prefabricated assembly is preferably connectable to a further component with a corresponding through-opening, which for example can also be produced from a sheet material. A planar bead, in which the individual through-opening is arranged, can be provided in the component or in the further component.

In the context of the invention, the expressions “approximately”, “substantially/essentially” or “roughly” mean deviations of +/−10%, preferably +/−5% from the respective exact values and/or deviations in the form of modifications of no significance for the function.

Further developments, advantages and possible uses of the invention also arise from the following description of exemplary embodiments and from the figures. All described and/or illustrated features, alone or in any combination, are in principle subject matter of the invention, regardless of the summarization thereof in the claims or the back references thereof. The content of the claims also constitutes a component of the description.

### BRIEF DESCRIPTION OF THE DRAWINGS

The invention is explained in more detail in the following, with reference to the figures and exemplary embodiments. Shown are:

FIG. 1 by way of example, a schematic longitudinal section through a floating, captive arrangement of a connection element on a component according to the invention,

FIG. 2 by way of example, a schematic longitudinal section through a connection element configured as a nut element having first locking means,

FIG. 3 by way of example, a schematic plan view of the underside of the connection element according to FIG. 2,

FIG. 4 by way of example, a schematic plan view of the underside of a retaining plate element,

FIG. 5 by way of example, a schematic longitudinal section through a component fabricated from a sheet material having second locking means,

FIG. 6 by way of example, a schematic plan view of the upperside of the component fabricated from a sheet material according to FIG. 5,

FIG. 7 by way of example, a schematic longitudinal section through an alternative floating, captive arrangement of a connection element on a component according to the invention,

FIG. 8 by way of example, a schematic longitudinal section through a connection element configured as a nut element having alternative first locking means,

FIG. 9 by way of example, a schematic plan view of the underside of the connection element according to FIG. 8,

FIG. 10 by way of example, a schematic longitudinal section through a component fabricated from a sheet material having alternative second locking means,

FIG. 11 by way of example, a schematic plan view of the upperside of the component fabricated from a sheet material according to FIG. 10,

FIG. 12 by way of example, a plan view of the upperside of an arrangement according to the invention having corresponding second locking means configured in the form of bead elements,

FIG. 13 by way of example, a section along the line A-A through the arrangement according to FIG. 12,

FIG. 14 by way of example, a section along the line B-B through the arrangement according to FIG. 12,

FIG. 15 by way of example, a schematic longitudinal section through a connection element having nose-like projections arranged on the underside of the head section as first locking means,

FIG. 16 by way of example, a schematic view of the underside of the connection element according to FIG. 15,

FIG. 17 by way of example, a schematic plan view of the upperside of a component having alternatively configured second locking means in the form of corresponding recesses,

FIG. 18 by way of example, a longitudinal section through the component according to FIG. 17,

FIG. 19 by way of example, a schematic longitudinal section through a connection element having recesses arranged on the underside of the head section as first locking means,

FIG. 20 by way of example, a schematic view of the underside of the connection element according to FIG. 19,

FIG. 21 by way of example, a schematic plan view of the upperside of a component having alternatively configured second locking means in the form of corresponding nose-like projections,

FIG. 22 by way of example, a longitudinal section through the component according to FIG. 21,

FIG. 23 by way of example, a lateral longitudinal section through an arrangement according to the invention in the form of a prefabricated assembly,

FIG. 24 by way of example, a first embodiment variant of an attachment of an arrangement according to the invention in the form of a prefabricated assembly to a further component,

FIG. 25 by way of example, a perspective illustration of an alternative embodiment variant of a floating, captive arrangement of a connection element on a component according to the invention configured in the form of a blind rivet element and

FIG. 26 by way of example, a longitudinal section through the arrangement according to FIG. 25.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

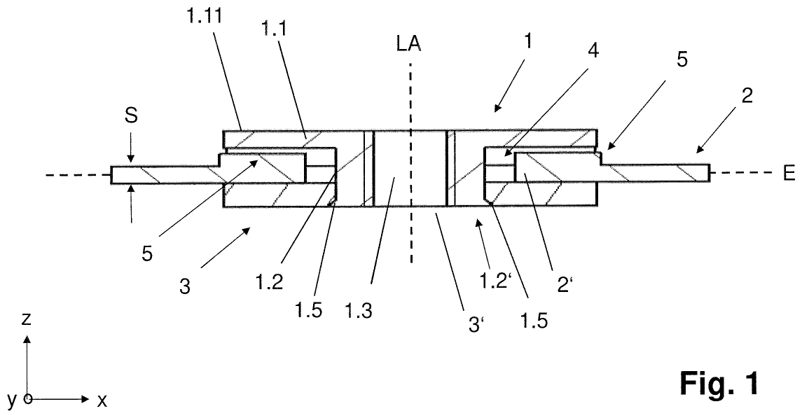

By way of example, FIG. 1 shows an arrangement according to the invention of a connection element 1 on a component 2 fabricated from a sheet material, in which the connection element 1 is both floatingly and captively arranged on the component 2. The component 2 can be made of metal or plastic, for example.

In this exemplary embodiment, the component 2 is formed by a panel-like component or a panel-like workpiece having at least one assembly area that is planar in sections. In an embodiment variant described in more detail further below, the component 2 can also be formed by a rivet sleeve element, in particular a blind rivet sleeve element, which is designed for receiving the connection element 1.

To make the arrangement according to the invention clearer, in individual figures a Cartesian coordinate system comprising an x-axis, a y-axis and a z-axis is sketched in. For example, the planar metal component 2 extends at least in the connection area along a plane E, which runs parallel to a plane defined by the x-axis and the y-axis. The connection element 1 furthermore extends along a longitudinal axis LA, which runs parallel to the z-axis.

In the context of the invention, a captively secured arrangement of the connection element 1 on the component 2 is understood to mean a fastening of the connection element 1 in or on the component 2, by means of which the connection element 1 in the assembled state is secured against loss and/or against being pressed out. For this, the connection element 1 is preferably inserted or passed, at least in sections, through a through-opening 2′ provided in the component 2 and is in particular secured against being pressed out of this through-opening 2′ of the component 2 along the z-axis. The through-opening 2′ is formed by a pre-perforation or a corresponding drilled hole or through-bore in the component 2, for example.

In the context of the invention, a floating arrangement of the connection element 1 on the component 2 is understood to mean an attachment of the connection element 1 on the component 2, which attachment is at least slidable or movable along plane E of the component 2; i.e., in the x-direction and/or y-direction. In addition, at least slight slidability along the z-axis can be provided. Owing to the resulting relative movability or slidability of the connection element 1 passed in sections through the through-opening 2′ in the component 2, a tolerance compensation with respect to the component 2 is possible during assembly by using the connection element 1 mounted thereon.

In this exemplary embodiment, the connection element 1 is formed by a threaded connection element, in particular a nut element. However, the invention is not in any way limited to a nut element; screw elements or bolt elements can also be floatingly and captively arranged in the component 2. The screw elements or bolt elements can also comprise, at least in sections, a female thread and/or a male thread.

In the arrangement depicted in FIG. 1, the connection element 1 extends along the z-axis; i.e., in the assembled state the longitudinal axis LA thereof extends approximately perpendicular to the plane E of the component 2, but at least to the plane E of the assembly area of the component 2. The connection element 1 furthermore comprises at least a head section 1.1 and a shaft section 1.2, which adjoins the head section 1.1 along the longitudinal axis LA and is set back in the direction of the longitudinal axis LA with respect to the head section 1.1. The edge or shell surfaces of the head section 1.1 and of the shaft section 1.2 thus have a different radial extension with respect to the longitudinal axis LA in order to block a passing through of the head section 1.1 through the through-opening 2′ in the component 2.

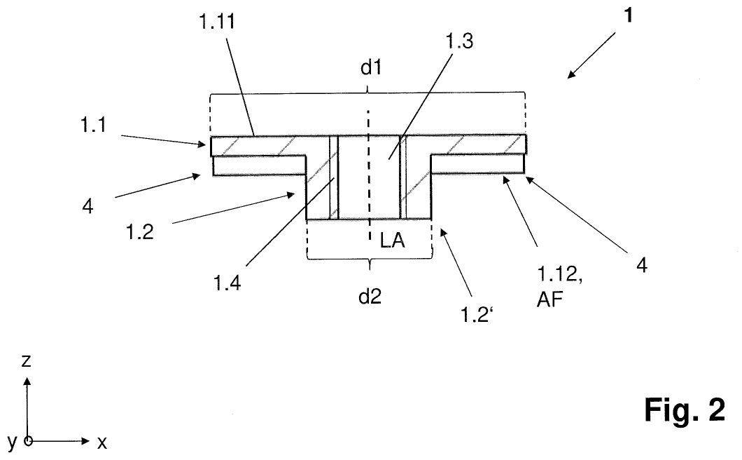

A schematic longitudinal section along the longitudinal axis LA through a connection element 1 configured as a nut element is illustrated by way of example in FIG. 2. The connection element or nut element 1 comprises, for example, a throughbore 1.3 extending along the longitudinal axis LA with a female thread 1.4, which throughbore preferably extends concentrically to the longitudinal axis LA completely through the head section 1.1 and shaft section 1.2 of the nut element 1. The diameter d1 of the head section 1.1 exceeds the diameter d2 of the shaft section 1.2, giving rise to a stepped transition between the head and shaft sections 1.1, 1.2.

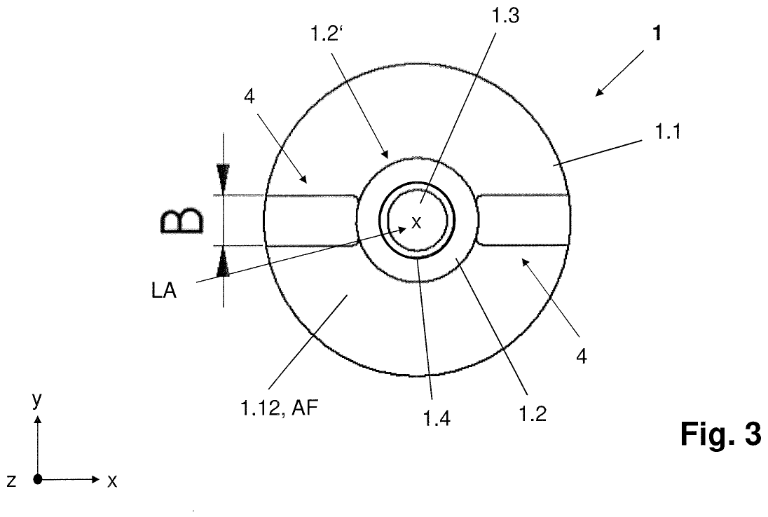

The head section 1.1 has an upperside 1.11 and an essentially annular underside 1.12, which, at least in sections, forms an abutment surface AF, which preferably extends parallel to the upperside of the head section 1.1 and concentrically around the longitudinal axis LA. By way of example, FIG. 3 shows a schematic view of the underside of the connection or nut element 1, illustrating the extension of the underside 1.12 or abutment surface AF of the head section 1.1 with respect to the free end 1.2′ of the shaft section 1.2.

For the floating and captive arrangement of the connection element 1 or nut element on the component 2, according to the invention a retaining plate element 3 is provided, which is preferably fabricated from a sheet metal material. The retaining plate element 3 has a through-opening 3′, which is preferably arranged in the center of the retaining plate element 3 and the diameter d3 and/or the cross-sectional shape of which is adapted to the diameter d2 and/or the cross-sectional shape of at least the free end 1.2′ of the shaft section 1.2 of the connection element 1.

The retaining plate element 3 is furthermore configured, in particular in terms of the outer dimensions and/or outer contour thereof, in such a way that the retaining plate element 3 connected to the free end 1.2′ of the shaft section 1.2 cannot be passed through the through-opening 2′ of the component 2. For example, the outer dimensions of the retaining plate element 3 exceed, at least in sections, the diameter d4 of the through-opening 2′ of the component 2.

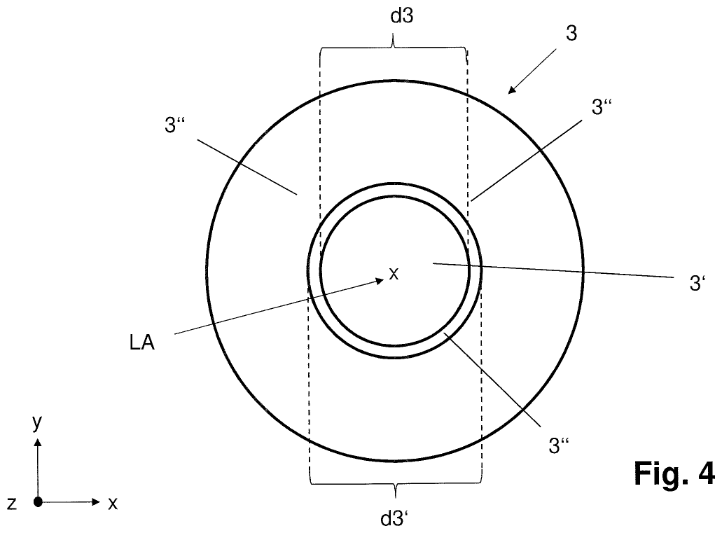

By way of example, FIG. 4 shows a schematic view of the underside of the retaining plate element 3 shown in FIG. 1. In this exemplary embodiment, the retaining plate element 3 is configured as a circular disc and has a circular through-opening 3′, which is adapted in terms of its diameter d3 to the diameter d2 of the shaft section 1.2, namely in such a way that the shaft section 1.2 with its free end 1.2′ is received, at least in sections, in the through-opening 3′ of the retaining plate element 3. Obviously, use can be made of through-openings 3′ with different, in particular polygonal, cross-sectional shapes. In this exemplary embodiment, the retaining plate element 3 furthermore has a transition section 3″, which runs obliquely to the longitudinal axis LA or to the underside of the retaining plate element 3 and extends between the inside of the through-opening 3′ and the underside of the retaining plate element 3. An oblique abutment or support surface forms as a result of the diameter d3′ widening from the diameter d3 of the through-opening 3′. Said surface can be configured as annular or, at least in sections, partially annular.

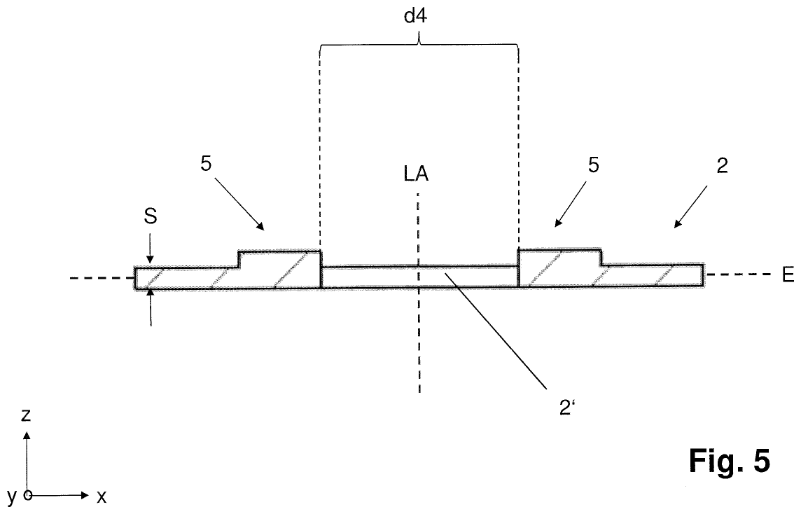

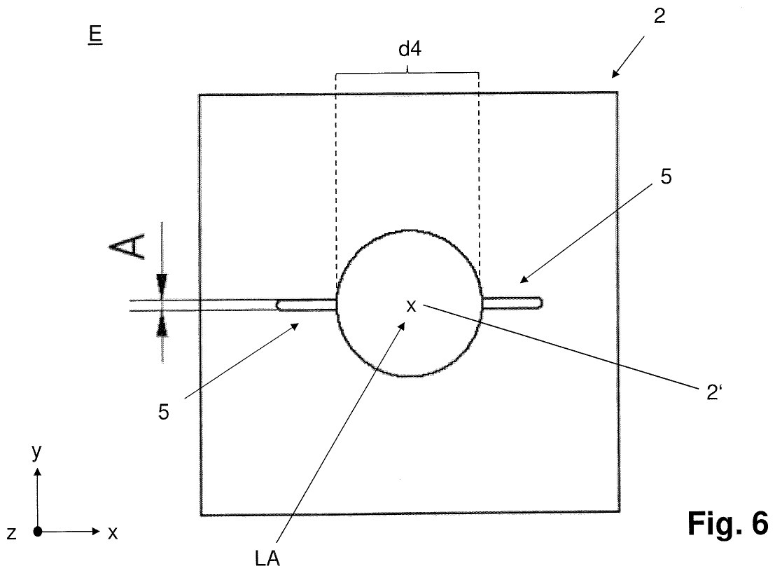

By way of example, a schematic longitudinal section through the component 2 according to FIG. 1 is illustrated in FIG. 5, and a schematic plan view of this embodiment variant of a component 2 is illustrated in FIG. 6, which component can be formed from, for example, a metal panel part and can in principle have any outer contour. In this exemplary embodiment, the component or metal panel part 2 has a component thickness S and is configured as rectangular or square when viewed from above.

As shown by way of example in FIG. 1, the shaft section 1.2 of the connection element 1 is passed in sections through the through-opening 2′ in the component 2 and connected, at least in the area of the free end 1.2′ of the shaft section 1.2 opposite the head section 1.1, to the retaining plate element 3 in such a way that the connection element 1 configured as a nut element is floatingly and captively arranged on the component 2. For this, for example, the end area of the free end 1.2′ of the shaft section 1.2 is plastically deformed outwardly, at least in sections, such that in the area of the through-opening 3′, the retaining plate element 3 is connected in a force-fitting and/or form-fitting manner to the free end 1.2′ of the shaft section 1.2 of the connection element 1, in particular such that the plastically deformed free edge section abuts on the obliquely running transition section 3″. As an alternative, use can be made of a press fit for the connection. The free end 1.2′ can also be formed by a free rivet collar section, which is deformable radially outwards, at least in sections, for captively attaching the retaining plate element 3.

The retaining plate element 3 is preferably arranged slidably along the longitudinal axis LA on the shaft section 1.2, wherein the connection between the free end 1.2′ of the shaft section 1.2 and the retaining plate element 3 is particularly preferably chosen in such a way that the end face of the free end 1.2′ of the shaft section 1.2 springs back relative to the underside of the retaining plate element 3, in other words does not protrude beyond the underside. It is thus possible to induce a pre-tensioning during the fabrication of the screw connection.

According to the invention, the head section 1.1 has first locking means 4 and the component 2 has corresponding second locking means 5, wherein the first locking means 4 interact with the corresponding second locking means 5 provided in the area of the through-opening 2′ of the component 2 in such a way that the connection element 1 received, at least in sections, in the through-opening 2′ of the component 2 is secured against at least section-wise twisting about the longitudinal axis LA relative to the component 2. The connection element 1 is thus not only arranged in the component 2 or received in the through-opening 2′ of the component 2 in a floating and captive manner, but also, at least partially or in sections, in a twist-proof manner. With the exception of a floating area X, this gives rise to an anti-twist lock.

The first and second locking means 4, 5 are preferably configured in such a way that they can be operatively connected to one another; i.e., at least one part or at least one section of the first locking means 4 comes in abutment with at least one part or at least one section of the second locking means 5, thus effectively preventing a twisting of the connection element 1 relative to the component 2 beyond a specified tolerance range or floating area X.

In the embodiment variant according to FIGS. 1 to 6, the first locking means 4 are formed, for example, by groove-like recesses in the abutment surface AF or in the underside 1.12 of the head section 1.1, which recesses have a width B. These recesses extend, for example, radially outwards from the shaft section 1.2 to the edge of the head section 1.1. Preferably two opposing groove-like recesses 4 are provided, which for example have a depth not greater than approximately half of the width of the head section 1.1. The groove-like recesses 4 preferably have U-shaped or C-shaped cross sections.

The second locking means 5 corresponding thereto are preferably in the form of web sections protruding from the upperside of the component 2 in the direction of the longitudinal axis LA, which are preferably formed in one piece or integrally with the component 2. In this exemplary embodiment, two web sections 5 running radially relative to the longitudinal axis LA are provided, which in terms of their radially longitudinal extension are adapted to the groove-like recesses 4; i.e., the radial length of the web sections 5 is preferably less than or equal to the radial length of the groove-like recesses 4. The web sections 5 furthermore have a width A, which is less than the width B of the groove-like recesses 4. The widths A, B are preferably chosen in such a way that they fulfill the following conditions:

B=A+X,

wherein X designates the specified floating area of the anti-twist locking; i.e., the first and second locking means 4, 5 are configured in such a way that a twisting about the longitudinal axis LA is still possible within the specified floating area X.

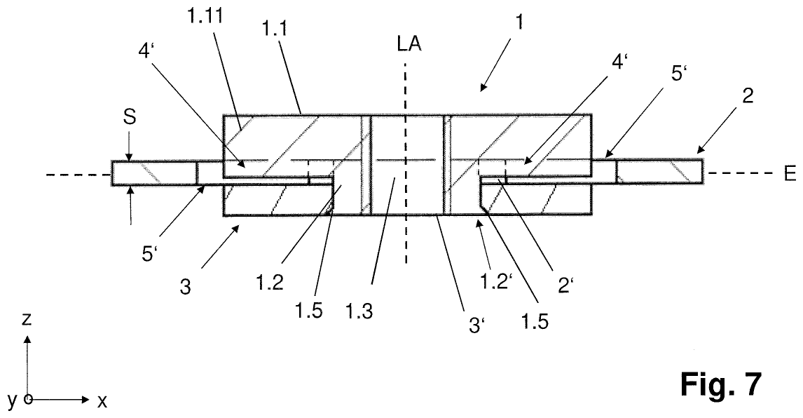

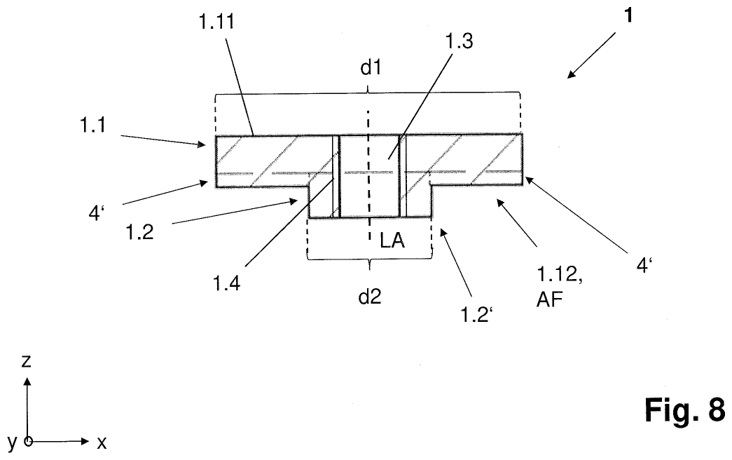

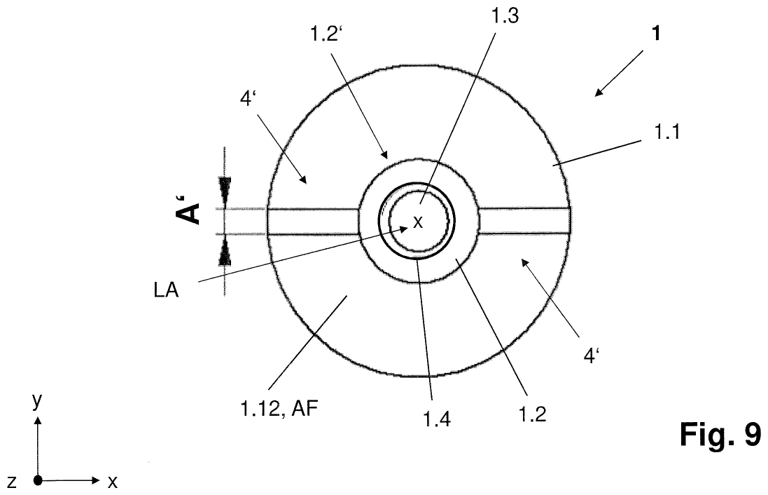

In an alternative embodiment variant according to FIGS. 7 to 11, for example, the first locking means 4 are formed by web sections 4′ protruding from the underside 1.12 of the head section 1.1 in the direction of the longitudinal axis LA, which are also preferably formed in one piece or integrally with the head section 1.1 or with the connection element 1. These web sections also run radially with respect to the longitudinal axis LA and extend from the shaft section 1.2 to the edge of the head section 1.1, on the underside 1.12 thereof. These web sections 4′ have a width A′ and are preferably rectangular or square in cross section. For establishing the operative connection, the corresponding second locking means 5 are formed analogously thereto by groove-like recesses 5′ in the upperside of the component 2, which recesses have a width B′ and are arranged in the area of the through-opening 2′.

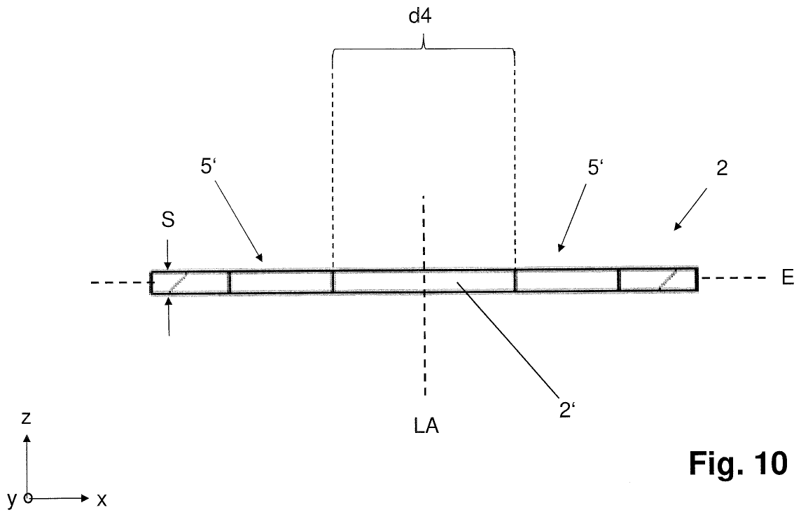

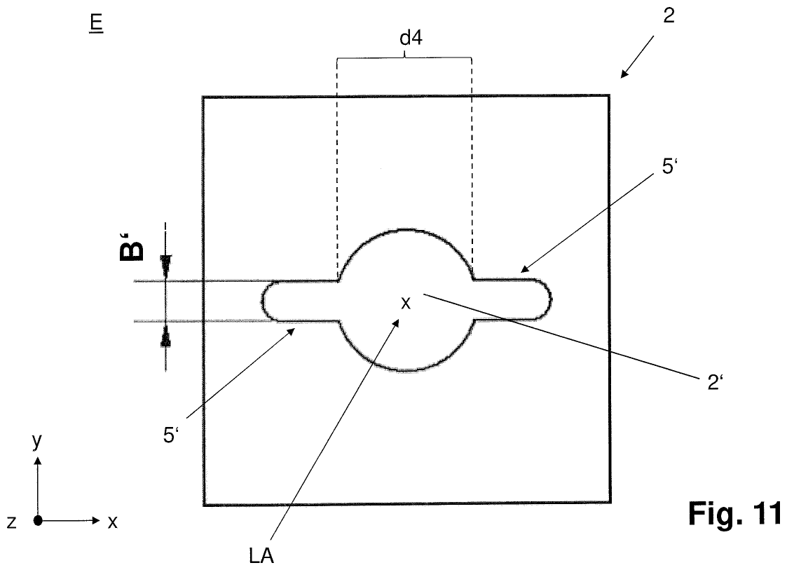

In this embodiment variant according to FIGS. 10 and 11, the groove-like recesses 5′ extend into the through-opening 2′; i.e., are configured as open towards the through-opening 2′, wherein the opposing end of the recess 5′, for example, can be rounded. In a preferred embodiment variant illustrated in FIGS. 10 and 11, the groove-like recesses 5′ extend over the entire thickness S of the component 2; i.e., they thus form groove-like through-openings that run radially outwards from the through-opening 2′ and preferably parallel to the plane E and along a straight line.

Again, preferably two opposing web sections 4′ and groove-like recesses 5′ are provided, wherein the groove-like recesses 5′ preferably have U-shaped or C-shaped cross sections. In terms of the radial longitudinal extension thereof, the web sections 4′ are adapted to the radial length of the groove-like recesses 5′. The widths A′, B′ are selected in such a way that they fulfill the following conditions:

B′=A′+X,

wherein X designates the specified floating area of the anti-twist locking; i.e., the first and second locking means 4′, 5′ are configured in such a way that a twisting about the longitudinal axis LA is still possible within the specified floating area X.

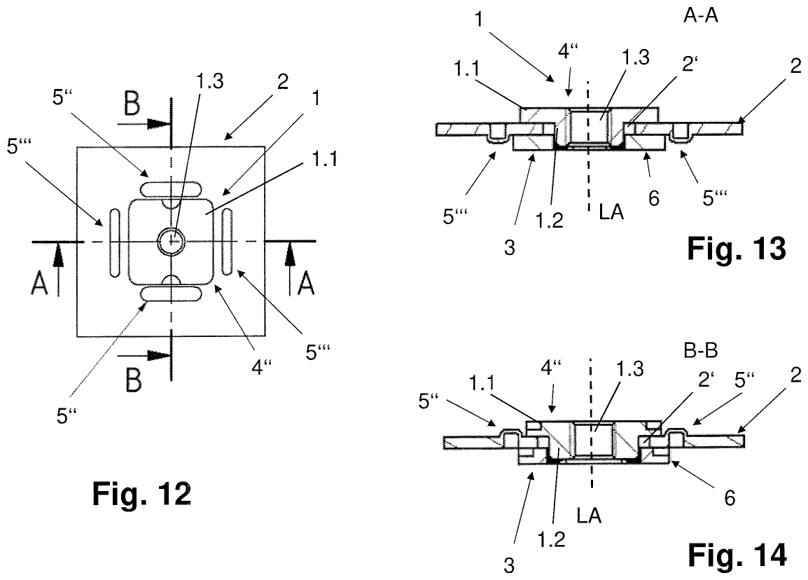

In another exemplary embodiment according to FIG. 12, the first locking means 4 of the head section 1.1 are formed by a cross-sectional shape 4″ of the head section 1.1 or at least by an edge section of the head section 1.1 deviating from the circular shape, which have a square cross-sectional shape in this exemplary embodiment. The corresponding second locking means 5 are configured, for example, in the form of at least one locking bead element 5″ protruding from the upperside of the component 2, which is formed for example by a web-like projection that protrudes from the upperside along the longitudinal axis LA and has, for example, a round or polygonal cross section. On the upperside of the component 2 at least one locking bead element 5″ is provided, which runs parallel to the edge of the head section 1.1 and which interacts with at least one edge section of the head section 1.1 in such a way that the edge section is brought into section-wise abutment on the locking bead element 5″, thus preventing a further twisting of the connection element 1 about the longitudinal axis LA.

In this exemplary embodiment, the second locking means 5 further comprise at least one locking bead element 5′″ protruding from the underside of the component 2, which likewise forms a web-like projection that protrudes from the underside along the longitudinal axis LA and has, for example, a round or polygonal cross section.

The locking bead elements 5′″ protruding from the underside of the component 2 interact with corresponding third locking means 6, which are provided on the retaining plate element 3 or are formed in one piece or integrally therewith. In this exemplary embodiment, the third locking means are formed by the selected cross-sectional shape of the retaining plate element 3, which in this case is square or rectangular. An arrangement comprising such first to third locking means 4, 5, 6 is illustrated by way of example in FIGS. 12 to 14, wherein in each case, for example, two locking bead elements 5″, 5′″ are provided, which are arranged parallel to one another and protrude from the upper- or underside, respectively, of the component 2. The two locking bead elements 5″ protruding from the upperside of the component 2 and the two locking bead elements 5″ protruding from the underside of the component 2 are preferably arranged relative to the through-opening 2′ in such a way that the head section 1.1 or the retaining plate element 3, respectively, is received between the two corresponding locking bead elements 5″, 5′. The respective edges of the head section 1.1 or of the retaining plate element 3 run parallel and spaced at a distance from the associated corresponding locking bead elements 5″, 5′″ such that the connection element 1 is still arranged floatingly on the component 2, but the connection element 1 is locked against twisting relative to the component about the longitudinal axis LA.

It shall be understood that, it is also possible to provide only third locking means 6 on the retaining plate element 3, which interact with the corresponding second locking means 5. The third locking means 6 can also be formed by nose-like projections or web sections protruding from the upperside of the retaining plate element 2 or by groove-like or circular recesses formed in the upperside of the retaining plate element 2, which interact with the correspondingly configured second locking means 5.

In another embodiment variant, the first locking means 4 can be formed on the head section 1.1 by nose-like projections 4′″, which protrude from the abutment surface AF or from the underside 1.12 towards the component 2 and in the direction of the longitudinal axis LA and which interact with corresponding locking recesses 5″″ on the upperside of the component 2. The locking recesses 5″″ thus form the corresponding second locking means 5.

The number and the diameter of the locking recesses 5″″ are adapted to the number and to the respective diameters of the nose-like projections 4′″ of the connection element 1. In particular, the arrangement relative to the longitudinal axis LA and the dimensioning of the diameters of the nose-like projections 4′″ or associated recesses are selected in such a way that in addition to anti-twist locking, a floating arrangement of the connection element 1 on the component 2 is still ensured.

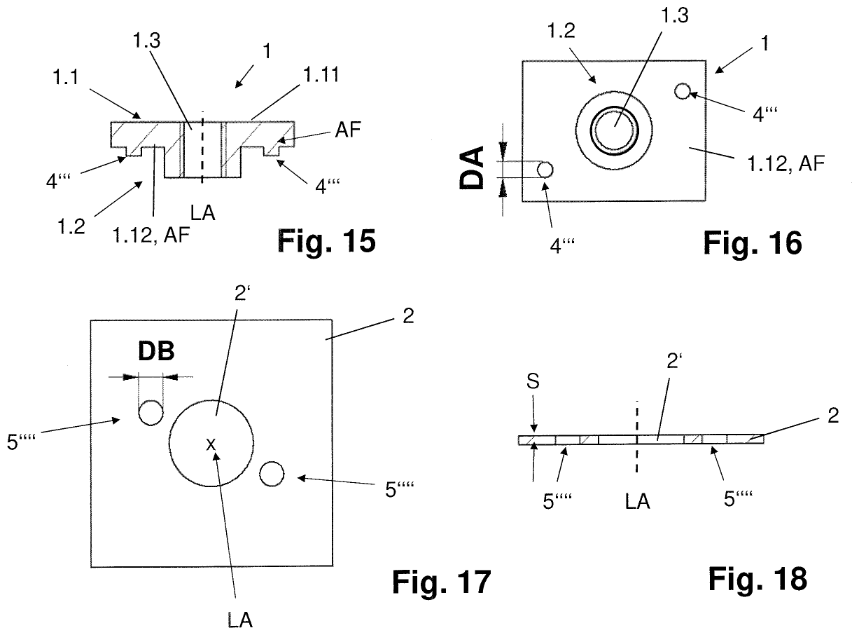

By way of example, FIG. 15 depicts a schematic longitudinal section through a connection element 1 configured as a nut element, in which at least one nose-like projection 4′″ is arranged on the abutment surface AF or underside 1.12 of the head section 1.1, which forms the first locking means 4 according to the invention. The at least one nose-like projection 4′″ extends along the longitudinal axis LA and is preferably arranged at a distance from the shell surface of the shaft section 1.2 or is molded thereon. In this exemplary embodiment, two nose-like projections 4′″ are provided, which oppose one another with respect to the longitudinal axis LA and which have, for example, circular cross sections. By way of example, FIG. 16 shows a schematic view of the underside 1.12 of the connection element 1 according to FIG. 15.

The nose-like projections 4′″ or first locking means 4 also interact with corresponding second locking means 5, which are formed in this exemplary embodiment by at least one recess 5″″ adapted to the cross-sectional shape and/or to the diameter of a nose-like projection 4″. The recess 5″″ is formed in the upperside of the component 2, in the area of the through-opening 2′, and extends at least partially over the thickness S of the component 2. By way of example, FIG. 17 depicts a plan view of the upperside of the component 2 and FIG. 18 depicts a schematic section through the longitudinal axis LA and the opposing recesses 5″″. Two recesses 5″″ are provided, which are adapted in terms of shape and positioning relative to the longitudinal axis LA to the arrangement of the nose-like projections 4′″. The recesses 5″″ preferably extend over the entire thickness S of the component and thus form through-openings through the component 2.

For example, the nose-like projections 4′″ are preferably rod-shaped, in particular cylinder-shaped. However, in principle diverse shapes that enable bracing, at least in sections, in the corresponding recesses 5″″ in the component 2 to generate anti-twist locking are possible.

For example, the nose-like projections 4′″ are configured as circular with a diameter DA, whereas the corresponding, also circular recesses have a diameter DB and, for providing a floating area X, fulfill the conditions:

DB=DA+X

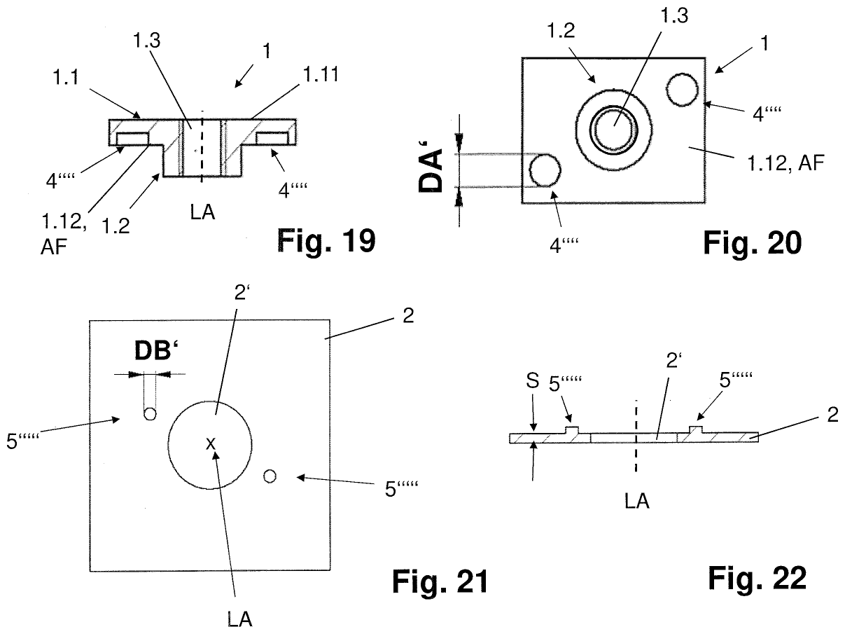

FIGS. 19 to 22 depict an embodiment variant in which the first and second locking means 4, 5 are mirror-inverted; specifically, the first locking means 4 are in the form of recesses 4″″ and the corresponding second locking means 5 are formed by nose-like projections 5′″″. The recesses 4″″ have a diameter DA′ and the nose-like projections 5′″″ have a diameter DB′ such that in this case also, the diameters DA′ and DB′ fulfill the following conditions for providing a floating area X:

DA′=DB′+X

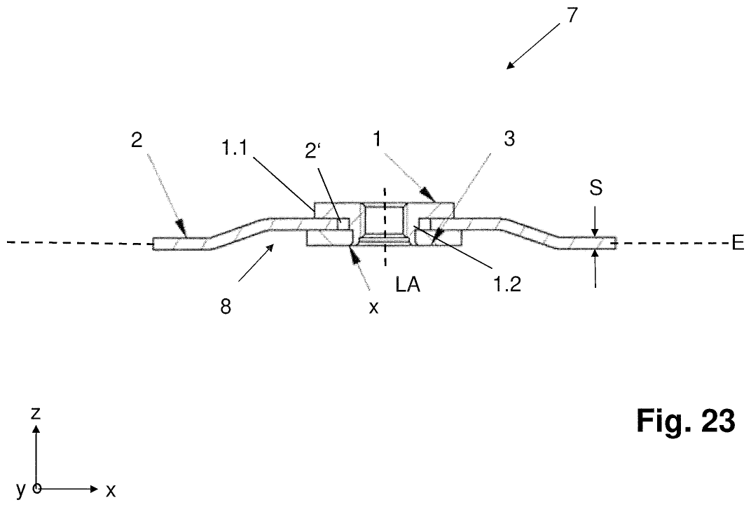

In another embodiment variant, the floating and captive arrangement according to the invention of a connection element 1 on a component 2 can form a prefabricated assembly 7 or pre-assembly. By way of example, a schematic longitudinal section through such an assembly 7 is depicted in FIG. 23. The assembly or attachment area is situated in a planar bead 8 in the component 2, whereby the assembly area is offset parallel to the plane E of the component 2, specifically in such a way that the retaining plate element 3 is received therein. The bead 8 is formed in the component 2 before the connection element 1 is introduced in the through-opening 2′. The countersunk arrangement of the retaining plate element 3 in the bead 8 pre-formed in the component 2 effectively prevents a sliding movement of the connection element 1 configured as, for example, a nut element.

Depending on the purpose and place of use, such an assembly 7 can be connected to a further component 9, which also has a through-opening 9′ which in the assembled state is preferably aligned with the through-opening 2′ of the component 2. The further component 9 extends, at least in the connection area, along the plane E, and the edge areas of the component 2 that enclose the bead 8 abut on the further component 9. The assembly 7 is preferably joined to the further component 9, specifically by means of welding, bonding, self-piercing riveting, blind riveting or clinching.

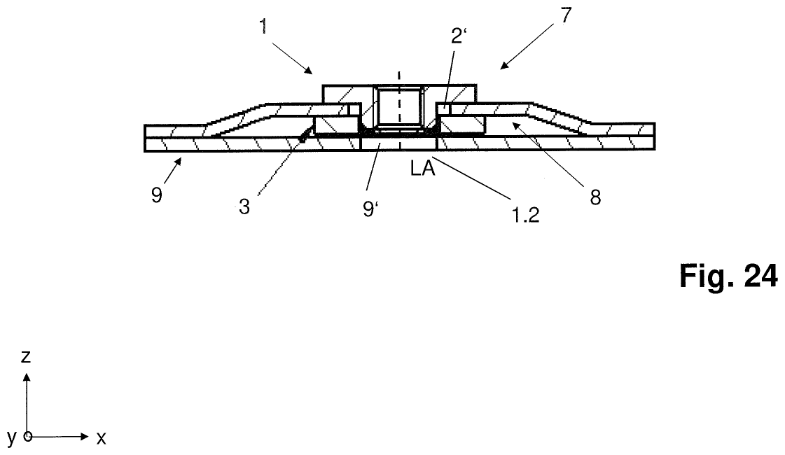

By way of example, an embodiment variant of an assembly 7 joined to a further component 9 is illustrated in FIG. 24. In the illustrated variant, a floating and captive arrangement of the connection element is also achieved in that the retaining plate element 3 is received in the bead 8 between both components 2, 9.

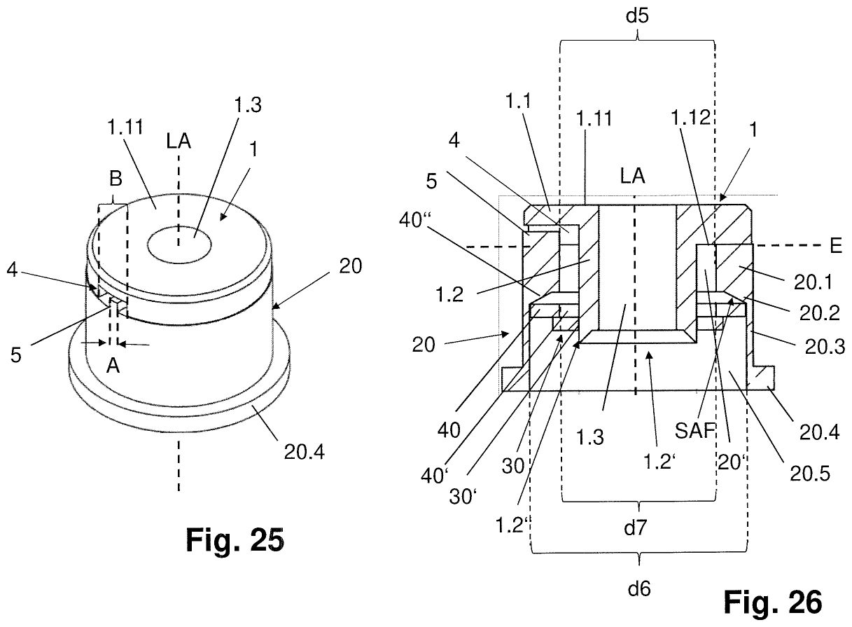

FIGS. 25 and 26 depict another embodiment variant of the inventive floating and captive arrangement of a connection element 1 on a component 2, in which the component 2 is formed by a blind rivet element 20. The blind rivet element 20 is provided for assembly on a component fabricated from a sheet material and to this end it is introduced on the assembly side into a pre-perforation in the component, and then a rivet connection is produced between the blind rivet element 20 and the component using a tension element.

The blind rivet element 20 also extends along the longitudinal axis LA and has at least one annular retaining section 20.1, which has a through-opening 20′. An abutment section 20.2 adjoins the annular retaining section 20.1 along the longitudinal axis LA, which abutment section forms an annular inner abutment surface SAF running obliquely to the longitudinal axis LA. The through-opening 20′ widens radially along the longitudinal axis LA in the abutment section 20.2. A rivet shaft section 20.3 and a directly adjoining rivet flange 20.4, which enclose a preferably cylindrical hollow rivet chamber 20.5, follow the annular abutment section 20.2 along the longitudinal axis LA. To produce a rivet connection, the rivet shaft section 20.3 can be deformed into a rivet collar, specifically by introducing a tension element into the connection element 1 and accordingly introducing a tension force via the connection element 1 in the annular retaining section 20.1 and in the abutment section 20.2 along the longitudinal axis LA, specifically in such a way that the rivet shaft section 20.3 deforms radially outward and forms a rivet collar by flanging accordingly. After establishment of the rivet connection, the component is received, preferably clamped, between the rivet collar thus formed and the rivet flange 20.4.

For a floating and captive arrangement of the connection element 1 in the blind rivet element 20, the shaft section 1.2 of the connection element 1 is inserted through the through-opening 20′ in the blind rivet element 20 and extends by its free end 1.2′ over the abutment section 20.2, at least in sections, into the hollow rivet chamber 20.5, specifically in the area of the rivet shaft section 20.3. The diameter d5 of the through-opening significantly exceeds the diameter d2 of the shaft section 1.2 of the connection element 1 so as to enable a tolerance compensation, in the x-/y-direction, of the connection element 1 received in the blind rivet element 20. The diameter d5 of the through-opening 20′ is between 10 mm and 14 mm, for example, wherein the diameter d2 of the shaft section 1.2 of the connection element 1 in this case is between 8 mm and 10 mm, for example. This preferably gives rise to a 2 mm to 4 mm floating area X. The diameter d5 of the through-opening 20′ widens over the abutment section 20.2 to the diameter d6 of the preferably cylinder-shaped hollow rivet chamber 20.5, which is between 14 mm and 18 mm, for example.

According to the invention, a retaining plate element 30 having a through-opening 30′, which is adapted to the diameter d2 of the shaft section 1.2 as described in the preceding, is provided in the area of the free end 1.2′ of the connection element 1. In the exemplary embodiment illustrated, the shaft section 1.2 of the connection element 1 has on the free end side a preferably annular rivet collar section 1.2″, the wall thickness of which decreases radially, specifically radially outwards from the inside relative to the longitudinal axis LA; i.e., the free end 1.2 of the shaft section formed by the rivet collar section 1.2″ tapers in cross section. For captively securing the connection element 1 introduced into the blind rivet element 20, the rivet collar section 1.2″ is deformable radially outwards and thus exceeds the diameter of the through-opening 30′ of the retaining plate element 30; i.e., the connection element 1 is protected from falling out or from being pressed out of the blind rivet element 20. Inducing a slight radially outward expansion of the rivet collar section 1.2″ by means of a suitable molding tool is enough to prevent the retaining plate element 30 from slipping off the shaft section 1.2.

The retaining plate element 30 is received between the abutment section 20.2 and the flanged, free rivet collar section 1.2″, wherein the outer diameter of the retaining plate element 30 is adapted in terms of shape and cross section to the dimensions and/or cross-sectional shape of the preferably cylindrical hollow rivet chamber 20.5, specifically in such a way that the retaining plate element 30 can be introduced along the longitudinal axis LA into the hollow rivet chamber 20.5 via the through-opening of the hollow rivet chamber 20.5 on the end face of the rivet flange 20.4.

To enlarge the floating area X of the arrangement, between the retaining plate element 30 and the abutment section 20.2 an abutment plate element 40 having an through-opening 40′ is provided, which abutment plate element 40 has an upperside edge bevel 40″, which is adapted to the oblique run of the abutment surface SAF of the abutment section 20.2 and which is preferably annular and lies flatly on the abutment surface SAF of the abutment section 20.2. The diameter d7 of the through-opening 40′ of the abutment plate element 40 corresponds approximately to the diameter of the through-bore 20′ of the blind rivet element 20 such that the through-bore 20′ continues in the through-opening 40′ of the abutment plate element 40. The underside of the abutment plate element 40 opposite the edge bevel 40″ is plane or planar and forms a plane or planar abutment surface for the retaining plate element 30 in direct abutment therewith such that even though the connection element 1 is captively secured, the floating area X established by the dimensions of the shaft section 1.2 and the through-opening 20′ of the blind rivet element 20 is still available.

Analogously to the embodiment variants according to FIGS. 1 to 6, in the embodiment variant according to FIGS. 25 and 26 the first locking means 4 are also formed, for example, by at least one groove-like recess in the underside 1.12 of the head section 1.1, which recess has a width B. This recess extends, for example, radially outwards from the shaft section 1.2 to the edge of the head section 1.1. The groove-like recess 4 preferably has a U-shaped or C-shaped cross section and a depth no greater than approximately half of the width of the head section 1.1.

The second locking means 5 corresponding thereto are configured in the form of, for example, at least one web section, which protrudes in the direction of the longitudinal axis LA from the upperside of the blind rivet element 20 or the end face of the annular retaining section 20.1 thereof and which is preferably formed in one piece or integrally with the blind rivet element 20. In this exemplary embodiment, provision is made of web sections 5 running radially relative to the longitudinal axis LA, which are adapted in terms of the radial longitudinal extension thereof to the groove-like recesses 4; i.e., the radial length of the web section 5 is preferably less than the radial length of the groove-like recesses 4. The web section 5 furthermore has a width A, which is less than the width B of the groove-like recess 4. The widths A, B are preferably selected in such a way that they also fulfill the following conditions:

B=A+X

The connection element 1 is thus inventively arranged in a floating, captive and twist-proof manner in or on the blind rivet element and is therefore also suitable for further processing as a prefabricated assembly. Obviously, the embodiment variants of the first and second locking means 4, 5 already described for a component 2 made of a sheet material can also be used for a component 2 formed by a blind rivet element 20.

The invention was described in the preceding with reference to exemplary embodiments. Obviously, numerous modifications and variations are possible without exceeding the underlying inventive concept of the invention.

### REFERENCE LIST

1 Connection element, in particular nut element
1.1 Head section
1.11 Upperside
1.12 Underside
1.2 Shaft section
1.2′ Free end
1.2″ Free rivet collar section
1.3 Through-bore
1.4 Female thread
1.5 Protruding material projections
2 Component
2′ Through-opening
3 Retaining plate element
3′ Through-opening
3″ Transition section
4 First locking means or groove-like recess
4′ Web sections
4″ Cross-sectional shape of the head section
4′″ Nose-like projections
4″″ Circular locking recesses
5 Corresponding second locking means or web section
5′ Groove-like recess
5″ Locking beads
5′″ Locking beads
5″″ Circular locking recesses
5′″″ Nose-like projections
6 Third locking means
7 Prefabricated assembly
8 Bead
9 Further component
9′ Through-opening
20 Blind rivet element
20′ Through-opening
20.1 Retaining section
20.2 Abutment section
20.3 Rivet shaft section
20.4 Rivet flange
20.5 Hollow rivet chamber
30 Retaining plate element
30′ Through-opening
40 Abutment plate element
40′ Through-opening
40″ Edge bevel
A, A′ Width
B, B′ Width
AF Abutment surface
DA, DA′ Diameter
DB, DB′ Diameter
d1 Diameter of the head section
d2 Diameter of the shaft section
d3 Diameter of the through-opening of the retaining plate element
d3′ Diameter of the transition section
d4 Diameter of the through-opening of the component
d5 Diameter of the through-opening of the blind rivet element
d6 Diameter of the hollow rivet chamber
d7 Diameter of the through-opening of the abutment plate element
E Plane of the component
LA Longitudinal axis
S Component thickness
SAF Abutment surface
X Floating area

1. A floating, captive arrangement, comprising:
a connection element on a component, in which the connection element extends along a longitudinal axis and has at least a head section and a shaft section, which adjoins the head section along the longitudinal axis and is set back relative to the head section, in which the shaft section is passed, at least in sections, through a through-opening in the component and is connected, at least in the area of the free end of the shaft section opposing the head section, to a retaining plate element in such a way that the connection element is floatingly and captively arranged on the component, wherein the head section has first locking means and/or the retaining plate element has third locking means and the component has respective corresponding second locking means, wherein the first locking means and/or third locking means interact with the second locking means in such a way that the connection element, which is received at least in sections in the through-opening of the component, is secured against at least section-wise twisting about the longitudinal axis relative to the component.

2. The arrangement according to claim 1, wherein the first, second and third locking means are arranged in the area of the through-opening of the component.

3. The arrangement according to claim 1, wherein the first, second and third locking means are configured in such a way that at least a part or at least a section of the first and/or third locking means comes in abutment with at least a part or at least a section of the second locking means as the connection element is turned.

4. The arrangement according to claim 1, wherein the component is received between the head section of the connection element and the retaining plate element.

5. The arrangement according to claim 1, wherein the retaining plate element produced from a sheet material has a through-opening, the diameter and/or the cross-sectional shape of which is adapted, at least in sections, to the diameter and/or to the cross-sectional shape of the shaft section of the connection element, in the area of the free end.

6. The arrangement according to claim 5, wherein the retaining plate element is captively connected to the free end of the shaft section of the connection element.

7. The arrangement according to claim 5, wherein the retaining plate element is secured against at least section-wise twisting about the longitudinal axis of the connection element at the free end of the shaft section of the connection element.

8. The arrangement according to claim 5, wherein the retaining plate element is arranged slidingly along the longitudinal axis on the shaft section of the connection element and/or that the free end of the shaft section is received in the through-opening of the retaining plate element in such a way that the free end springs back from the underside of the retaining plate element into the through-opening.

9. The arrangement according to claim 1, wherein the retaining plate element has an outer contour and/or outer dimensions that block a passing through of the retaining plate element through the through-opening of the component.

10. The arrangement according to claim 1, wherein the first locking means are formed by at least one groove-like recess formed in the underside of the head section and that the corresponding second locking means are formed by at least one web section protruding from the upperside of the component in the direction of the longitudinal axis.

11. The arrangement according to claim 1, wherein the first locking means are formed by at least one web section protruding from the underside of the head section and that the corresponding second locking means are formed by at least one groove-like recess formed in the upperside of the component.

12. The arrangement according to claim 10, wherein the groove-like recess has a U-shaped or C-shaped cross-section and/or that the at least one groove-like recess and the at least one web section extend radially to the longitudinal axis, wherein the at least one web section is adapted in terms of the radial longitudinal extension to the radial longitudinal extension of the groove-like recess.

13. The arrangement according to claim 10, wherein the web sections have a width which is less than the width of the groove-like recesses.

14. The arrangement according to claim 10, wherein the first and second locking means are each formed by at least two groove-like recesses or at least two web sections.

15. The arrangement according to claim 1, wherein the first locking means are formed by at least one nose-like projection protruding from the underside of the head section and that the corresponding second locking means are formed by at least one circular locking recess formed in the upperside of the component.

16. The arrangement according to claim 1, wherein the first locking means are formed by at least one circular locking recess formed in the underside of the head section and that the corresponding second locking means are formed by at least one nose-like projection protruding from the upperside of the component.

17. The arrangement according to claim 15, wherein the circular locking recess and the nose-like projections are adapted to each other in terms of number, shape and/or positioning relative to the longitudinal axis.

18. The arrangement according to claim 1, wherein the first locking means are formed by a cross-sectional shape of the head section or from at least one edge section of the head section deviating from the circular shape.

19. The arrangement according to claim 18, wherein the corresponding second locking means are formed by at least one locking bead element, which protrudes from the upperside of the component.

20. The arrangement according to claim 18, wherein the third locking means are formed by a cross-sectional shape of the retaining plate element or from at least one edge section of the retaining plate element deviating from the circular shape, which interact with corresponding second locking means that are formed by at least one locking bead element that protrudes from the underside of the component.

21. The arrangement according to claim 1, wherein the at least one locking bead element is molded into the sheet material that forms the component.

22. The arrangement according to claim 1, wherein the third locking means are formed by at least one nose-like projection and/or web section protruding from the upperside of the retaining plate element, which interact(s) with corresponding second locking means in the form of recesses.

23. The arrangement according to claim 1, wherein the third locking means are formed by at least one recess formed in the upperside of the retaining plate element, which interacts with corresponding second locking means in the form of a nose-like projection and/or web section protruding from the underside of the component.

24. The arrangement according to claim 1, wherein the connection element is configured as a nut element, a bolt element or a screw element.

25. The arrangement according to claim 1, wherein the through-opening in the component and/or the through-opening in the retaining plate element is/are formed by a pre-perforation or a drilled hole.

26. The arrangement according to claim 1, wherein the component is formed by a blind rivet element with a through-opening comprising a retaining section, an abutment section, a rivet shaft section, and a rivet flange, which adjoin one another along the longitudinal axis.

27. The arrangement according to claim 26, wherein the through-opening extends over the retaining section to the abutment section and transitions along the abutment section, widening in cross section, into a preferably cylinder-shaped hollow rivet chamber, which is enclosed by the rivet shaft section and by the rivet flange adjoining the latter.

28. The arrangement according to claim 26, wherein the abutment section forms an annular abutment surface that runs obliquely to the longitudinal axis.

29. The arrangement according to claim 26, wherein an abutment plate element having a through-opening and an upperside edge bevel is arranged between the retaining plate element and the abutment section arranged captively on the free end of the shaft section and that the abutment plate element with the edge bevel abuts flatly on the abutment surface of the abutment section running obliquely to the longitudinal axis.

30. The arrangement according to claim 26, wherein the diameter of the through-opening of the abutment plate element corresponds approximately to the diameter of the through-opening of the retaining section.

31. The arrangement according to claim 26, wherein the retaining plate element abuts on the underside of the abutment plate element, wherein the outer diameter of the retaining plate element is smaller than the diameter of the hollow rivet chamber and larger than the diameter of the through-opening of the abutment plate element.

32. A prefabricated assembly comprising an arrangement according to claim 1.

33. The prefabricated assembly according to claim 32, wherein the component is connected to a further component having a corresponding through-opening.
